(19) United States
(12) Patent Application Publication
(10) Pub. No.: US 2015/0108762 A1
(43) Pub. Date: Apr. 23, 2015

(54) Aerogenerator Comprising a Trunk and a Plurality of Branches Extending From This Trunk

(71) Applicant: NEWWIND, Paris (FR)

(72) Inventor: Jérôme Michaud-Lariviere, Paris (FR)

(73) Assignee: NEWWIND, Paris (FR)

(21) Appl. No.: 14/385,447

(22) PCT Filed: Oct. 17, 2012
(86) PCT No.: PCT/IB2012/055655

§ 371 Date: Dec. 8, 2014

(30) Foreign Application Priority Data
Mar. 14, 2012 (FR) 1252295

(51) Int. Cl. F03D 9/00; F03D 3/00

(52) U.S. Cl. CPC F03D 9/002; F03D 3/005
USPC 290/55

(57) ABSTRACT

The invention relates to an aerogenerator comprising a trunk and a plurality of branches extending from this trunk, characterized in that it comprises: a plurality of turbines distributed over the various branches, each turbine having a vertical axis of rotation; and an electric generator mounted inside each turbine on the axis of rotation of said turbine.

The invention relates to an aerogenerator.

An aerogenerator, also known as a wind turbine, is an electric generator that produces electricity from wind energy.

More specifically, the invention relates to an aerogenerator comprising a trunk and a plurality of branches extending from this trunk.

Such aerogenerators resemble actual trees and can be integrated into a landscape while minimizing the visual impact.

Patent WO 2011/132130 proposes such an aerogenerator, in this case in the shape of a fir tree, where the turbines are mounted on a common shaft housed in the trunk and forming the rotor of the electric generator.

In such a design, failure of the electric generator implies a complete shutdown of electricity production.

This problem can be avoided with other designs.

For example, patent US 2010/0289269 proposes another aerogenerator in tree form. In one embodiment a plurality of turbines are provided, each of them associated with an electric generator placed near the turbine.

In this manner, if a generator fails it is still possible to produce electricity.

To achieve this, the electric generator is mounted inside the branch, at the end of the branch which is arranged horizontally. The turbine, in the form of a propeller, has a hub mounted on the axis of rotation of the rotor of the electric generator.

However, this arrangement is not optimal for technical and aesthetic reasons.

In addition, each propeller-like turbine has blades extending radially relative to the arm supporting said turbine. This arrangement is necessary in order to obtain a horizontal propeller shaft that is rotatable by the wind.

This results in a significant radial size which limits the possibilities for arranging the different turbines relative to each other. Moreover, it should be noted that patent US 2010/0289269 proposes installing these turbines at the end of each branch only, presumably to avoid a shielding effect between two turbines located on the same branch.

It also results in a general shape which is difficult to compare to that of a tree.

In addition, having the electric generator installed within the branch itself does not facilitate cooling and increases the risk of overheating.

One object of the invention is to overcome at least one of these problems.

In particular, an object of the invention is to provide an aerogenerator in which the shape of the turbines optimizes the uptime of each turbine and reduces the risk of failure of the electric generator.

Also in particular, another object of the invention is to provide an aerogenerator in which the shape of the turbines and their respective arrangement is optimized to minimize the shielding effects between different turbines.

To this end, the invention proposes an aerogenerator comprising a trunk and a plurality of branches extending from the trunk, characterized in that it comprises:
a plurality of turbines distributed over the different branches, each turbine having a vertical axis of rotation, and
an electric generator mounted inside each turbine on the axis of rotation of said turbine.

The aerogenerator according to the invention may also include one or more of the following characteristics, alone or in combination:
each turbine has at least two curved parts extending along said axis, each of these parts comprising an opening adjacent to said axis, and the electric generator is housed inside the turbine so that a gap is maintained between the electric generator and the edges of the openings;
at least some of the turbines have a torpedo shape for which the longitudinal axis coincides with the axis of rotation of the turbine;
at least some of the turbines are Savonius type turbines, meaning that they have at least two semi-cylindrical curved parts offset relative to each other so as to define said openings;
the aerogenerator comprises between 80 and 150 turbines, each turbine having curved parts whose total surface area is between 8 cm² and 64 cm²;
at least some of the turbines comprise a stiffening frame secured at two points of the axis of rotation of the turbine;
the stiffening frame follows the outside contours of each part of the turbine;
each turbine has a shape similar to that of a tree leaf;
each turbine is made of a material selected from among: polycarbonate, polyethylene, a metal which is preferably non-oxidizable, a steel, or a wood such as bamboo;
the electric generator comprises: at least one rotor mounted on the axis of rotation of the turbine, annular in shape and provided with permanent magnets; and a stator mounted on a frame of the turbine, annular in shape and comprising coils intended to interact with the permanent magnets of the rotor;
the electric generator comprises two identical rotors, said rotors being arranged one on each side of the stator which has, on each of its faces, coils facing the permanent magnets of the rotor concerned;
the permanent magnets are arranged at the edge of the or of each rotor and the coils are arranged at the edge of the stator;
it comprises at least one tube supporting at least one turbine, said at least one tube being mounted on a branch,
said at least one tube is detachably mounted on said branch;
each branch comprises a plurality of turbines;
the branches are detachably mounted on the trunk;
the trunk is made as one piece and comprises a plurality of receptacles for said branches, these receptacles being arranged at different heights along the trunk and at different angular positions around the trunk;
the trunk comprises a plurality of sections attached to each other, each section comprising at least one receptacle for a branch, said receptacles being arranged at different heights along the trunk and at different angular positions around the trunk.

The invention will be better understood and other objects, features and advantages thereof will be more apparent from reading the following description which is made with reference to the accompanying drawings, in which:

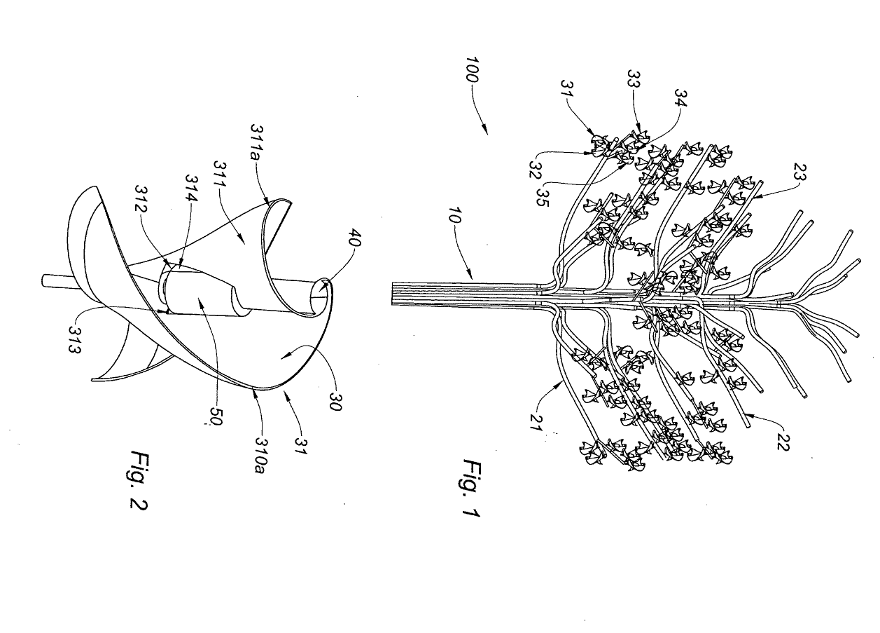

FIG. 1 shows a front view of an aerogenerator according to the invention;

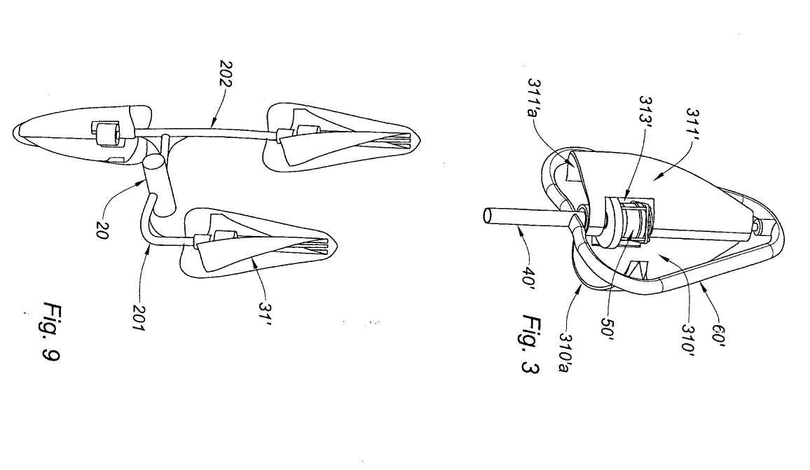

FIG. 2 shows a perspective view of an exemplary turbine of the invention which can be used in the aerogenerator of FIG. 1;

FIG. 3 shows a perspective view of another exemplary turbine of the invention which can be used in the aerogenerator of FIG. 1;

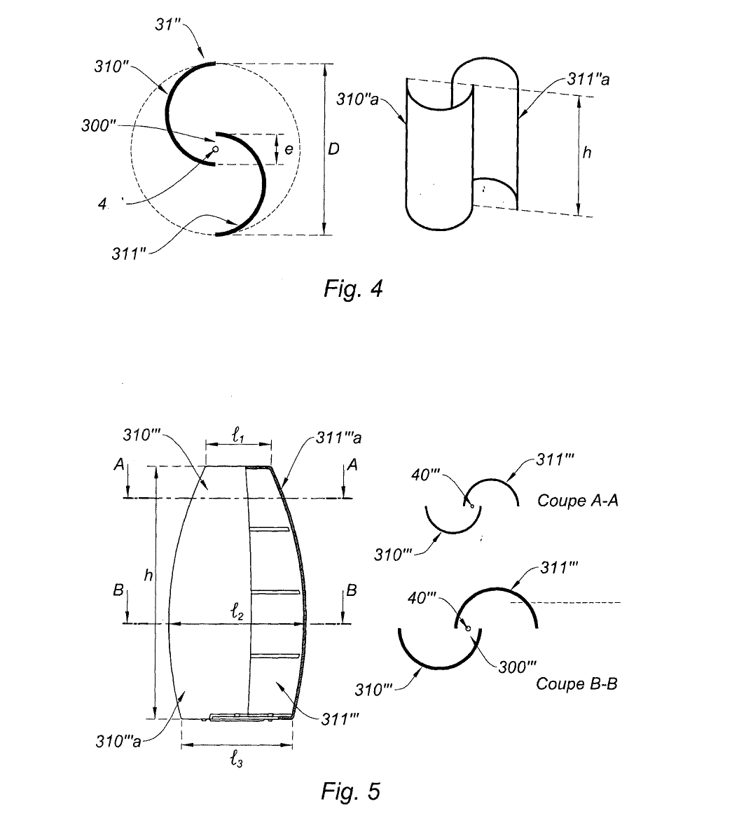

FIG. 4 shows a top view and a perspective view of another exemplary turbine which can be used in the aerogenerator of FIG. 1;

FIG. 5 shows a side view and two sectional views of another exemplary turbine which can be used in the aerogenerator of FIG. 1;

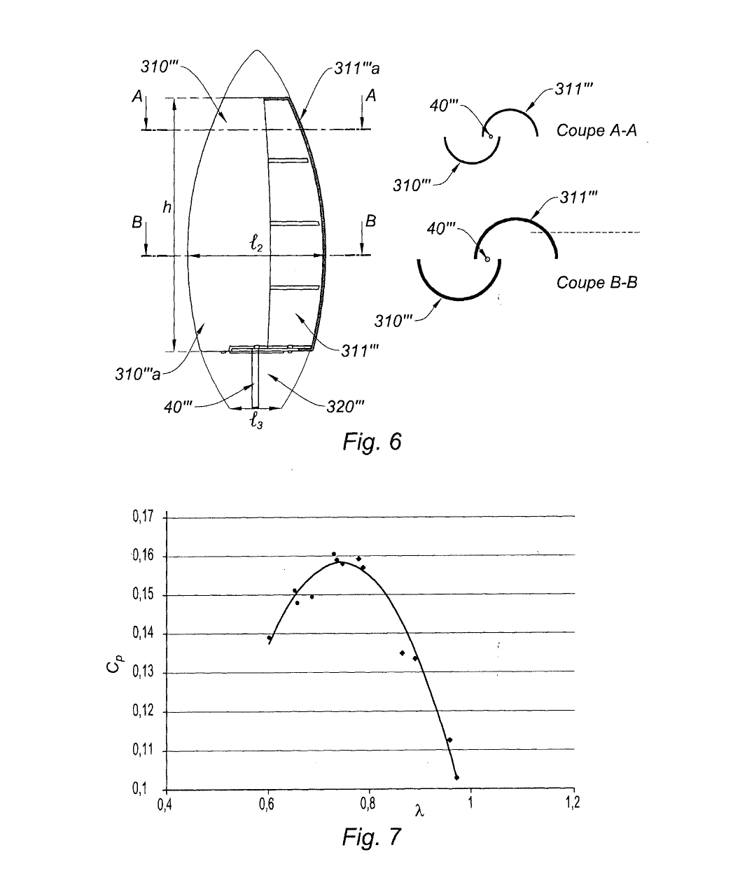

FIG. 6 shows a variant of the turbine shown in FIG. 5;

FIG. 7 shows the power curve of the turbine shown in FIG. 5;

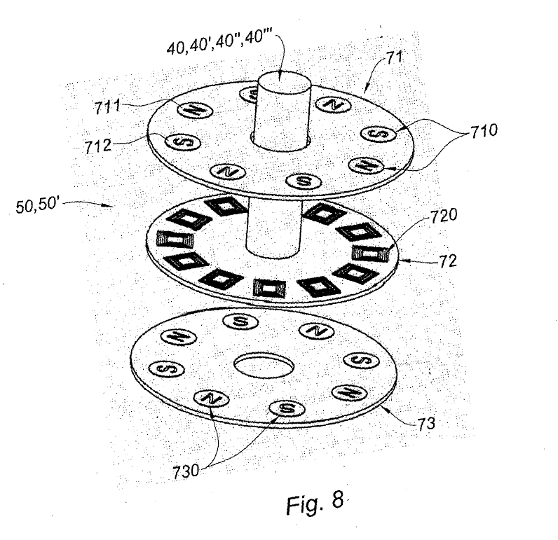

FIG. 8 shows an exploded view of an electric generator that can be used with any of turbines shown in the other accompanying figures;

FIG. 9 shows a perspective view of a subset of the aerogenerator shown in FIG. 1, having turbines as shown in FIG. 3;

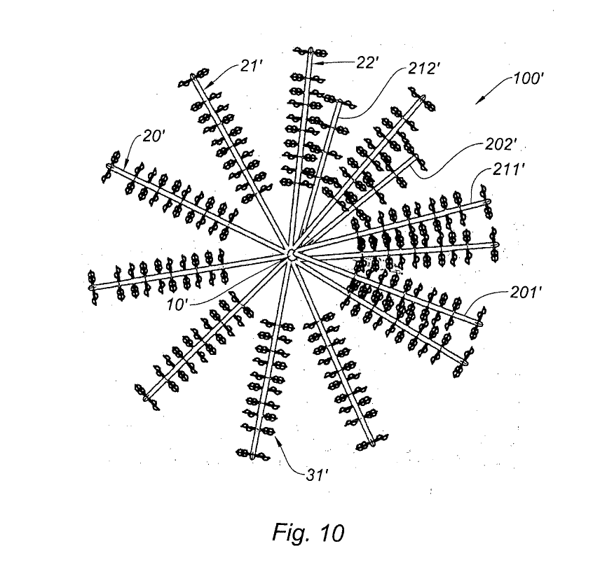

FIG. 10 shows a top view of another aerogenerator according to the invention.

An aerogenerator 100 according to the invention is shown in FIG. 1.

This aerogenerator 100 comprises a trunk 10 and a plurality of branches 20, 21, 22, 23 extending from the trunk 10.

In FIG. 1, the trunk 10 is formed by the set of tubes forming the various branches.

However, it is possible to have a trunk made as a single piece to which the branches are mounted.

In another variant, it is possible to have a trunk made by securing different sections together, with each branch mounted on a dedicated section.

Advantageously, the branches are detachably mounted on a trunk made as a single piece or from multiple sections. Having branches 20, 21, 22, 23, 24 detachably mounted on the trunk facilitates maintenance.

Each branch 20, 21, 22, 23, 24 comprises at least one turbine. For example, branch 20 has five turbines denoted 31, 32, 33, 34, 35.

The turbines of the aerogenerator 100 are arranged so that their axis of rotation is vertical.

Each turbine 31 has an associated electric generator 50 comprising a rotor and a stator. The axis of rotation 40 of the turbine 31 corresponds to the longitudinal axis (of rotation) of the rotor and therefore to the longitudinal axis of the electric generator.

If one of the generators breaks down, the aerogenerator 100 can therefore continue to produce electricity.

The electric generator 50 is housed inside the turbine 31.

This has several advantages.

By arranging the electric generator 50 inside the turbine 31, the electric generator is exposed to the wind. This facilitates cooling and reduces its risk of failure.

In addition, installing the electric generator 50 inside the turbine 31 stiffens the assembly formed by the turbine 31 and electric generator 50. It therefore meets the rigidity constraints needed for high wind resistance.

In addition, this reduces the diameter of the axis of rotation 40 of the turbine 31, compared to the diameter that would be required to obtain the same stiffness without the presence of the electric generator 50. The radial dimensions of the turbine 31 are therefore reduced and the shielding effect on another turbine is decreased.

The decrease in the shielding effect is of interest because it allows increasing the number of turbines on a given aerogenerator, if so desired, while ensuring that all turbines are exposed to the wind.

The electric generator 50 may be an AC generator or a DC generator, basing the choice on cost constraints in particular.

A first exemplary turbine 31 with a vertical axis of rotation and usable in the invention is shown in FIG. 2.

This turbine 31 has two parts 310, 311 extending along the longitudinal axis 40 of the turbine.

This longitudinal axis coincides with the axis of rotation of the turbine 40.

Advantageously, the parts 310, 311 are curved to better catch the wind. This reduces the threshold value below which the turbine 31 can overcome the rotational resistance.

This is particularly true as compared to the propeller-shaped turbine with a horizontal axis proposed in patent US 2010/0289269, when it has comparable dimensions.

The uptime of the aerogenerator 100 and its performance are thereby improved.

A curved shape also has the advantage of being comparable to a leaf shape. Better integration of the aerogenerator 100 with the surrounding landscape is therefore obtained.

In addition, each part 310, 311 of the turbine 31 has an opening 312, 313 adjacent to the axis of rotation 40 of the turbine 31.

The electric generator 50 is therefore housed between the two parts 310, 311 of the turbine 31.

The respective arrangement of the electric generator 50 and the openings 312, 313 is such that a gap 314 is maintained between said electric generator and the edges of said openings 312, 313.

The electric generator 50 thus does not interfere with the rotation of the turbine 31 about its axis.

In addition, this gap 314 offers a particular advantage.

When wind hits one 310 of the two parts 310, 311 of the turbine 31, a portion of the wind rushes into this space 314 which allows interaction with the other part 311 of the turbine 31.

This reduces slightly further the wind speed threshold below which the turbine 31 can operate against the rotational resistance.

The uptime of the aerogenerator 100 and its performance are thus further improved.

This reinforces the interaction effect between the two parts 310, 311 of the turbine 31.

The turbine described in relation to FIG. 2 has two parts 310, 311 having helical outer edges 310a, 311a.

Other turbine shapes can be considered, however.

A second exemplary turbine with a vertical axis of rotation is described below with reference to FIG. 3.

In this example, the two curved portions 310′, 311′ of the turbine 31′ have helical outer edges 310′a, 311′a while defining a torpedo shape having a longitudinal axis that coincides with the axis of rotation of the turbine 31′.

Unlike the embodiment shown in FIG. 2, the radius of each part 310′, 311′ is therefore not constant along the axis of rotation 40′ of the turbine 31′.

The shape of the turbine 31′ is even more comparable to that of a tree leaf.

The electric generator 50 is mounted between the two parts 310′, 311′ of the turbine 31′, by means of an opening 313′ in each part 310′, 311′.

In addition, a stiffening frame 60′ may be provided to strengthen the turbine 31′. This frame 60′ is for example attached at two points on the axis of rotation 40′ of the turbine 31′.

Advantageously, the frame 60′ follows the outer edges 310′a, 311′a of the two parts 310′, 311′ of the turbine 31′ in order to reduce the radial dimensions and consequently the shielding effect on another turbine.

It should be noted that such a stiffening frame may also be provided on the turbine 31 described in reference to FIG. 2.

In a third example, as shown in FIG. 4, the turbine 31″ could be based on a simple “Savonius” type turbine, meaning the outer edges 310″a, 311″a of the two curved parts 310″, 311″ of the turbine are straight lines, with the possibility of a stiffening frame as described above. This solution is less advantageous in terms of aesthetics, however. In FIG. 4, the turbine 31″ is shown in a top view on the left and in a perspective view on the right. D is the diameter, h is the height, and e is the offset between the curved parts about the axis.

In a known manner, a “Savonius” turbine is a turbine with a vertical axis of rotation 40″ that comprises two curved parts, each semi-cylindrical in shape and offset relative to each other to leave an opening between them.

In a fourth example, as shown in FIG. 5, the turbine 31′″ is a variant of the turbine 31″ of FIG. 4.

This is a “Savonius” type turbine as it has two curved semi-cylindrical parts which are offset relative to each other to define an opening allowing the wind to pass between them. However, the outer edges 310′″ a, 311′″a of the parts/blades 310′″, 311′″ of the turbine 31′″ curve outward. In other words, this is a “Savonius” type of turbine with outer edges 310′″a, 311′″a defining a torpedo-shaped turbine. The torpedo shape is such that its longitudinal axis coincides with the axis of rotation 40′″ of the turbine 31′″. The exemplary turbines described above have two curved parts.

In such cases, these parts are preferably arranged symmetrically relative to the axis of rotation of the turbine, as this symmetry ensures optimum turbine operation.

However, turbines having more than two curved parts extending along the axis of rotation of the turbine are also possible.

In this case, the different parts of the turbine, which are attached or molded to the axis of rotation of the turbine, are advantageously distributed at regular angular intervals about the axis. This distribution ensures optimum turbine operation.

In all cases, the turbines described above comprise a plurality of curved parts extending along the axis of rotation of the turbine, as well as openings formed in these parts and adjoining the axis of rotation of the turbine in order to accommodate the electric generator.

These openings may be formed anywhere in the relevant portions (blades) of the turbine. FIG. 2 shows openings 312, 313 centered along the axis of rotation 40 at the edge of the parts 310, 311 of the turbine 31. FIG. 3 shows openings 313′ which are off-center in a lower region of the parts 310′, 311′ of the turbine 31′. Finally, FIG. 6 shows openings located at the lower ends of the two parts forming the turbine.

FIG. 6 is a variant of FIG. 5, in which an extension of the curved parts of the turbine define a hollow internal volume 320′″ within the turbine, which allows accommodating the electric generator. The turbine blades are therefore not present in this volume. The various turbines shown in FIG. 2, 3 or 4 may have such an extension at the bottom.

It should be noted that in the case of turbines based on the “Savonius” form, in other words the turbines represented in FIGS. 4 and 5, the opening 300″, 300′″ that is part of the “Savonius” form and which allows wind to travel from one blade to the other may be sufficient to accommodate the generator without the different parts of the turbine being pierced the way they are in FIG. 2 or 3. To establish the correlation with the turbines shown in FIGS. 2 and 3, it should be noted that the opening 300″ (respectively 300′″) corresponds to the opening formed by combining the two openings 312, 313 of FIG. 2. Other forms of turbines with a vertical axis of rotation can be considered. Thus, one can consider a “Darrieus” type turbine or one that combines “Darrieus” and “Savonius” technologies. Given the form of these turbines, no opening in the different parts of the turbine is made, but the electric generator is still exposed to the action of the wind. These solutions, although possible, remain less advantageous than those described for example in relation to FIGS. 2 and 3.

Typically, a turbine 31, 31′ as shown in FIGS. 2 and 3 can have a wind contact surface area of about 600 cm². For example, in the case of the turbines 31, 31′ shown in FIG. 2 or 3, this surface area can be obtained with a turbine having a height of about 40 cm and a width of about 15 cm.

Rotation of the turbine thus begins below a wind speed of 2 m/s, or even below 1 m/s.

In addition, when a turbine 31, 31′ has a surface area of about 600 cm², it should be noted that about 300 turbines provides a total power output of around 3 kW.

However, the turbines shown in FIG. 4, 5 or 6 are more efficient in terms of yield, at equal surface areas, than the turbines shown in FIG. 2 or 3.

Thus, to obtain a total power output of about 3 kW, it is possible to implement between 80 and 150 turbines, with the wind capture surface area of each turbine being between 8 cm² and 64 cm². The wind capture surface area corresponds to the total surface area of all parts/blades forming the turbine.

More precisely, one can envisage using between 80 and 120 turbines, the turbines having blade surface areas of between 10 cm² and 20 cm², to deliver at least 3 kW. In practice, this defines a tree about 8 m in height.

One can also envisage using between 120 and 150 turbines, the turbines having blade surface areas of between 10 cm² and 20 cm², to deliver at least 3 kW. In practice, this defines a tree about 12 m in height.

The performance of the turbine 31′″ of FIG. 5 is represented in FIG. 7 for the case where I₁=145 mm, I₂=310 mm, and I₃=247 mm. The width I₁ is the width of the turbine 31′″ at its upper end, the width I₂ corresponds to its maximum width, and the width I₃ is the width of the turbine 31′″ at its lower end. This turbine is associated with an electric generator as described below with reference to FIG. 8, arranged at the base of the turbine, the radius of the or of each associated rotor here being r=95 mm.

FIG. 7 shows the evolution of the coefficient of power Cₚ of the turbine as a function of a speed ratio λ.

The coefficient of power Cₚ is the ratio of the actual power generated by the turbine (P_{turbine}) to the maximum power that can be extracted from the wind (P_{wind}), or Cₚ=P_{turbine}/P_{wind}.

The power of the turbine is measured data.

The maximum power that can be extracted from the wind can be expressed as follows:

P_{wind}=½*ρₐᵢᵣ*S*V³

where:
ρₐᵢᵣ is the air density;
S is the total surface area of the blades of the turbine
V is the wind speed.

The speed ratio λ is defined as follows:

λ=(ωᵣ*Rᵣ)/V

where:
ωᵣ is the angular speed of rotation of the rotor of the electric generator, which corresponds to the angular speed of rotation of the axis of rotation of the turbine;
Rᵣ is the radius of the rotor of the electric generator;
V is the wind speed.

In general, it should be noted that the widths I₁ and I₃ of this turbine 31′″ can be zero. This is the case for example for length I₁ of FIG. 6.

The turbine may be made of a material selected from among: polycarbonate, polyethylene, a metal that is preferably non-oxidizable, a steel, or a wood such as bamboo.

Some of the accompanying figures schematically show the generator 50, 50′.

This generator 50, 50′ may have a specific design, as shown in the exploded view in FIG. 8.

Thus, a first disc 71 forming the rotor can be mounted on the axis of rotation 40, 40′, 40″, 40′″ of the turbine. This first disc 71 comprises a plurality of permanent magnets 710 arranged at its edge. Adjacent magnets along this edge alternate in polarity (north/south). Thus, there are “north” polarity magnets 711 and “south” polarity magnets 712.

A second disk 72 is arranged facing the first disc 71. This second disc 72 forms the stator and is therefore mounted on a support frame of the turbine (not shown) so that it is not rotated by the axis of rotation of the turbine. It has coils 720 intended to interact with the permanent magnets 710 located on the rotor 71.

Advantageously and as shown in FIG. 8, a third rotor disk 73 is provided, identical to the first rotor disk 71. This second rotor 73 is mounted on the axis of rotation of the turbine. The stator 72 is therefore arranged between the two rotors 71, 73. The stator 72 comprises coils 720 arranged at the edge of a first face of said stator which are intended to interact with the permanent magnets 710 of the first rotor 71, and coils (not visible in FIG. 8) arranged at the edge of a second face of the stator 72 which are intended to interact with the permanent magnets 730 of the second rotor 73.

The coils are preferably implemented in a printed circuit.

This type of generator is extremely compact. It therefore has the advantage of being able to accommodate a maximum number of stator windings and a maximum number of magnets or each rotor while being compact, especially radially.

It can therefore easily be housed in the curved/blade parts of the turbine, without enlarging the turbine which would impact the amount of wind caught by the other turbines.

In addition, the opening made in the blades of the turbine can thus be relatively thin since the generator is thin, typically less than 2-3 cm. This is of interest because a high blade surface area can be maintained while retaining the possibility of the wind traveling from one blade to another through the openings formed therein. The disc shape of the electric generator is therefore particularly suitable for maintaining turbine performance.

FIG. 9 shows a subset of the aerogenerator shown in FIG. 1, having turbines as shown in FIG. 3.

On the branch 20 of the aerogenerator 100, one or more tubes 201, 202 supporting one or more turbines are mounted, preferably detachably.

For example, tube 201 supports turbine 31′ of FIG. 3.

Detachably mounting these tubes 201, 202 on a branch 20 facilitates removal of a turbine 31′ when a failure occurs.

In addition, the tubes 201, 202 allow managing the respective arrangement of the turbines on the aerogenerator 100 as desired.

Advantageously, all the turbines are mounted on the branches by means of such tubes 201, 202.

This makes it easy to construct an aerogenerator of the desired shape. The advantage is aesthetic, as it is thus possible for the shape of the aerogenerator to be more similar to that of a tree. The advantage is also technical, because the arrangement achieved with these tubes 200, 201 limits the shielding effect between turbines. FIG. 10 shows a top view of another aerogenerator 100′ according to the invention. It comprises a trunk 10′ made of a single piece or of several segments attached to each other, as described above. Each branch is equipped with turbines 31′, which are for example those in FIG. 4.

This type of trunk 10′ allows forming receptacles for the branches which can be best distributed to limit the shielding effects between turbines.

In FIG. 10, one can thus see a plurality of first branches 20′, 21′, 22′ located at the same height and distributed at different angular positions around the trunk 10′.

The aerogenerator 100′ also has a plurality of second branches 201′, 211′ distributed at different angular positions around the trunk 10′ and located at a greater height than said first plurality of first branches.

The aerogenerator 100′ further comprises a plurality of third branches 202′, 212′ distributed at different angular positions around the trunk 10′ and located at a lower height than said first plurality of first branches.

Thus, when the trunk 10′ is made as one piece, the receptacles are arranged at different heights along the trunk 10′ and at different angular positions around the trunk 10′.

When the trunk 10′ comprises a plurality of sections attached to each other, each section contains at least one receptacle for a branch. The receptacles are then arranged at different heights along the trunk 10′ and at different angular positions around the trunk 10′ because of the respective positions of the various sections. It should be noted that when tubes 201, 202 as described in relation to FIG. 9 are used, optimal positioning of the various turbines relative to each other to limit the shielding effect between said turbines is obtained.

The invention described above may relate to an aerogenerator 100, 100′ comprising a trunk 10, 10′ and a plurality of branches 20, 21, 22, 23, 20′, 21′, 22′, 23′, 201′, 211′, 202′, 212′ extending from the trunk 10, 10′, characterized in that it comprises:
a plurality of turbines 31, 32, 33, 34, 35, 31′, 31″, 31′″ distributed over the different branches, each turbine having a vertical axis of rotation 40, 40′, 40″, 40′″, and
an electric generator 50, 50′ mounted inside each turbine on the axis of rotation of said turbine.

The other features described above may be combined with these key features.

However, the invention could relate to an aerogenerator 100, 100′ comprising a trunk 10, 10′ and a plurality of branches 20, 21, 22, 23, 20′, 21′, 22′, 23′, 201′, 211′, 202′, 212′ extending from said trunk 10, 10′, characterized in that it comprises:
a plurality of turbines 31, 32, 33, 34, 35, 31′, 31″, 31′″ distributed over the different branches, each turbine having a vertical axis of rotation 40, 40′, 40″, 40′″;
an electric generator 50, 50′ comprising: at least one rotor 71, 73 mounted on the axis of rotation 40, 40′, 40″, 40′″ of each turbine, annular in shape and provided with permanent magnets 710 arranged at the edge of said rotor 71, 73; and a stator mounted on a frame of the turbine, annular in shape and comprising coils intended to interact with the permanent magnets of the rotor 71, 73.

The advantages of this aerogenerator are primarily related to the compact size of the electric generator. This allows it to be housed within the turbine without appreciably impacting the performance or size of said turbine. This limits the effects of potential interactions between the different turbines of the aerogenerator. Other advantages of this configuration are described above.

These key features can be combined with the following features, alone or in combination.

Advantageously, an electric generator with two identical rotors 71, 73 is provided, said rotors being arranged one on each side of the stator 72 which has, on each of its faces, coils facing the permanent magnets 710, 730 of rotor 71, 73 concerned.

Generally, each rotor 71, 73 will have a permanent magnet of “north” polarity alternating with a permanent magnet of “south” polarity.

The permanent magnets are advantageously arranged at the edge of the or of each rotor.

Advantageously, each electric generator 50, 50′ is mounted inside the turbine concerned.

Advantageously, each electric generator 50, 50′ is mounted inside the lower portion of the turbine.

In addition, each turbine 31, 32, 33, 34, 35, 31′, 31″, 31′″ may have at least two curved parts 310, 311, 310′, 311′ extending along said axis, each of these parts having an opening 312, 313, 313′ adjacent to said axis, and the electric generator 50, 50′ is housed inside the turbine so that a gap 314 is maintained between the electric generator and the edges of the openings.

At least some of the turbines 31′, 31′″, preferably all of them, have a torpedo shape for which the longitudinal axis coincides with the axis of rotation of the turbine.

At least some of the turbines, preferably all of them, are Savonius type turbines, meaning that they have at least two semi-cylindrical curved parts offset relative to each other so as to define said openings.

Between 80 and 150 turbines may be provided, each turbine having curved parts whose total surface area is between 8 cm² and 64 cm ².

The nature of the materials forming the turbine can be selected from the list defined above.

A stiffening frame may also be provided, as described above.

Moreover, the tree arrangement (existence of a tube 200, 201, detachably mounting this tube on the tree, detachably mounting the branch on the trunk, etc.) as described in relation to FIGS. 9 and 10 can be applied to this other definition of the invention.

Thus, the aerogenerator 100, 100′ may comprise at least one tube 200, 201 supporting at least one turbine 31, 32, 33, 34, 35, 31′, 31″, 31′″, said at least one tube being mounted on a branch 20.

Said at least one tube 200, 201 may be detachably mounted on said branch 20.

Each branch 20, 21, 22, 23 may comprise a plurality of turbines 31, 32, 33, 34, 35, 31′, 31″, 31′″.

The branches 20′, 21′, 22′, 23′, 201′, 211′, 202′, 212′ may be detachably mounted on the trunk 10′.

The trunk 10′ may be made as one piece and comprises a plurality of receptacles for said branches, these receptacles being arranged at different heights along the trunk and at different angular positions around said trunk.

The trunk 10′ may comprise a plurality of sections attached to each other, each section comprising at least one receptacle for a branch, said receptacles being arranged at different heights along the trunk and at different angular positions around said trunk.

According to another definition of the invention, it could concern an aerogenerator 100, 100′ comprising a trunk 10, 10′ and a plurality of branches 20, 21, 22, 23, 20′, 21′, 22′, 23′, 201′, 211′, 202′, 212′ extending from said trunk 10, characterized in that it comprises:
a plurality of between 80 and 150 turbines 31, 32, 33, 34, 35, 31′, 31″, 31′″ distributed over the different branches, at least some of the turbines being Savonius type turbines, meaning that they have a vertical axis of rotation 40, 40′, 40″, 40′″ and at least two semi-cylindrical curved parts offset relative to each other and defining openings in the turbine, said curved parts of a turbine having a total surface area of between 8 cm² and 64 cm², and
an electric generator 50, 50′ mounted on the axis of rotation of each turbine.

The intrinsic characteristics of a turbine (shape, surface area) and the number of turbines are carefully chosen to maximize the electrical power generated by the aerogenerator, given various aesthetic constraints (shape of the leaves) and technical constraints such as the shielding effect between neighboring turbines.

Advantageously, all the turbines are Savonius type turbines.

In this case, each turbine may have a torpedo shape for which the longitudinal axis coincides with the axis of rotation of the turbine.

Furthermore, the electric generator 50, 50′ can be mounted inside the turbine concerned, for example in its lower portion.

When the electric generator 50, 50′ is housed inside the turbine, a gap 314 is provided between the electric generator and the edges of the openings.

In addition, the electric generator 50, 50′ may comprise: at least one rotor 71, 73 mounted on the axis of rotation 40, 40′, 40″, 40′″ of each turbine, annular in shape and provided with permanent magnets 710, 730; and a stator mounted on a frame of the turbine, annular in shape and comprising coils 720 intended to interact with the permanent magnets of the rotor 71, 73.

Advantageously, an electric generator with two identical rotors 71, 73 is provided, said rotors being arranged one on each side of the stator 72 which has, on each of its faces, coils facing the permanent magnets of the rotor concerned.

Advantageously, the permanent magnets 710, 730 are mounted at the edge of the or of each rotor. Similarly, the coils 720 are advantageously mounted at the edge of the stator 72.

The nature of the materials forming the turbine can be selected from the list defined above.

A stiffening frame may also be provided, as described above.

Moreover, the tree arrangement (existence of a tube 200, 201, detachably mounting this tube on the tree, detachably mounting the branch on the trunk, etc.) as described in relation to FIGS. 9 and 10 can be applied to this other definition of the invention.

Thus, the aerogenerator 100, 100′ may comprise at least one tube 200, 201 supporting at least one turbine 31, 32, 33, 34, 35, 31′, 31″, 31′″, said at least one tube being mounted on a branch 20.

Said at least one tube 200, 201 may be detachably mounted on said branch 20.

Each branch 20, 21, 22, 23 may comprise a plurality of turbines 31, 32, 33, 34, 35, 31′, 31″, 31′″.

The branches 20′, 21′, 22′, 23′, 201′, 211′, 202′, 212′ may be detachably mounted on the trunk 10′.

The trunk 10′ may be made as one piece and comprises a plurality of receptacles for said branches, these receptacles being arranged at different heights along the trunk and at different angular positions around said trunk.

The trunk 10′ may comprise a plurality of sections attached to each other, each section comprising at least one receptacle for a branch, said receptacles being arranged at different heights along the trunk and at different angular positions around said trunk.

1. An aerogenerator comprising a trunk and a plurality of branches extending from said trunk, characterized in that it comprises:
a plurality of turbines distributed over the different branches, each turbine having a vertical axis of rotation, and
an electric generator mounted inside each turbine on the axis of rotation of said turbine.

2. The aerogenerator according to claim 1, wherein each turbine has at least two curved parts extending along said axis, each of these parts comprising an opening adjacent to said axis, and wherein the electric generator is housed inside the turbine so that a gap is maintained between the electric generator and the edges of the openings.

3. The aerogenerator according to claim 1, wherein at least some of the turbines have a torpedo shape for which the longitudinal axis coincides with the axis of rotation of the turbine.

4. The aerogenerator according to claim 2, wherein at least some of the turbines are Savonius type turbines, meaning that they have at least two semi-cylindrical curved parts offset relative to each other so as to define said openings.

5. The aerogenerator according to claim 4, wherein it comprises between 80 and 150 turbines, each turbine having curved parts whose total surface area is between 8 cm2 and 64 cm2.

6. The aerogenerator according to claim 1, wherein at least some of the turbines comprise a stiffening frame secured at two points of the axis of rotation of the turbine.

7. The aerogenerator according to claim 6, wherein the stiffening follows the outside contours of each part of the turbine.

8. The aerogenerator according to claim 1, wherein each turbine has a shape similar to that of a tree leaf.

9. The aerogenerator according to claim 1, wherein each turbine is made of a material selected from among: polycarbonate, polyethylene, a metal that is preferably non-oxidizable, a steel, or a wood such as bamboo.

10. The aerogenerator according to claim 1, wherein the electric generator comprises:
at least one rotor mounted on the axis of rotation of the turbine, annular in shape and provided with permanent magnets; and
a stator mounted on a frame of the turbine, annular in shape and comprising coils intended to interact with the permanent magnets of the rotor.

11. The aerogenerator according to claim 10, wherein the electric generator comprises two identical rotors, said rotors being arranged one on each side of the stator which has, on each of its faces, coils facing the permanent magnets of the rotor concerned.

12. The aerogenerator according to claim 10, wherein the permanent magnets are arranged at the edge of the or of each rotor and wherein the coils are also arranged at the edge of the stator.

13. The aerogenerator according to claim 1, wherein it comprises at least one tube supporting at least one turbine, said at least one tube being mounted on a branch.

14. The aerogenerator according to claim 13, wherein said at least one tube is detachably mounted on said branch.

15. The aerogenerator according to claim 1, wherein each branch comprises a plurality of turbines.

16. The aerogenerator according to claim 1, wherein the branches are detachably mounted on the trunk.

17. The aerogenerator according to claim 1, wherein the trunk is made as one piece and comprises a plurality of receptacles for said branches, these receptacles being arranged at different heights along the trunk and at different angular positions around said trunk.

18. The aerogenerator according to claim 1, wherein the trunk comprises a plurality of sections attached to each other, each section comprising at least one receptacle for a branch, said receptacles being arranged at different heights along the trunk and at different angular positions around said trunk.
